(19) United States
(12) Patent Application Publication
(10) Pub. No.: US 2021/0241025 A1
(43) Pub. Date: Aug. 5, 2021

(54) OBJECT RECOGNITION METHOD AND APPARATUS, AND STORAGE MEDIUM

(71) Applicant: Beijing More Health Technology Group Co. Ltd., Beijing (CN)

(72) Inventors: Jin ZHAO, Beijing (CN); Fei KONG, Beijing (CN); Hai WANG, Beijing (CN); Bangchang LIU, Beijing (CN); Shufeng GU, Beijing (CN); Hongwen ZHAO, Beijing (CN); Xiaobin LUO, Beijing (CN); Dejie CHANG, Beijing (CN); Chaozhen LIU, Beijing (CN); Yikun ZHANG, Beijing (CN); Yunzhao WU, Beijing (CN); Boran ZHUANG, Beijing (CN); Xiaofei YUAN, Beijing (CN)

(73) Assignee: Beijing More Health Technology Group Co. Ltd., Beijing (CN)

(21) Appl. No.: 17/238,215

(22) Filed: Apr. 23, 2021

Related U.S. Application Data
(63) Continuation of application No. PCT/CN2021/083025, filed on Mar. 25, 2021.

(30) Foreign Application Priority Data
Oct. 28, 2020 (CN) 202011167365.5

(51) Int. Cl. G06K 9/62; G06K 9/46

(52) U.S. Cl. CPC G06K 9/627; G06K 9/46; G06K 2209/17; G06K 9/6215; G06K 9/6202

(57) ABSTRACT

This application provides an object recognition method and apparatus, and a storage medium, and relates to the technical field of image recognition. The object recognition method includes: receiving an image of an object to be recognized; inputting the image of the object to be recognized into a pre-trained image feature extractor to obtain a first feature vector of the image of the object to be recognized; and determining category information of the object to be recognized according to the first feature vector of the image of the object to be recognized as well as image feature vectors in an image database, wherein the image database includes image information of a plurality of objects.

### CROSS-REFERENCE TO RELATED APPLICATION

This application is a continuation of international PCT application NO. PCT/CN2021/083025 filed on Mar. 25, 2021 which claims the priority benefit of China application No. 202011167365.5 filed on Oct. 28, 2020. The entirety of the above-mentioned patent applications is hereby incorporated by reference herein and made a part of this specification.

### TECHNICAL FIELD

This application relates to the technical field of image recognition, in particular to an object recognition method and apparatus, and a storage medium.

### BACKGROUND

With the continuous improvement of living standards, people pay more and more attention to their health, and how to manage their diet efficiently, scientifically and effectively has become a problem that people have to face every day. Recording the daily diet by handwriting or typing is cumbersome and uninteresting, while recognizing the name of a dish from the image of the dish and obtaining relevant information is fast, efficient, and interesting.

At present, dish recognition is usually implemented based on image classification technology. Specifically, with a given dish dataset, a dish classification model is trained according to a loss function for classification (usually the cross-entropy loss function), and the completed classification model is used for dish recognition.

However, for the existing dish recognition methods, when there is an unbalance between the categories of the dish dataset, the classification of the classification model will be ineffective.

### SUMMARY

In order to solve the problems in the prior art, the present application provides an object recognition method and apparatus, and a storage medium.

In order to achieve the above object, the present application adopts the following technical scheme:

A first aspect of the present application provides an object recognition method, including: receiving an image of an object to be recognized;

inputting the image of the object to be recognized into a pre-trained image feature extractor to obtain a first feature vector of the image of the object to be recognized; and
determining category information of the object to be recognized according to the first feature vector of the image of the object to be recognized as well as image feature vectors in an image database, wherein the image database contains image information of a plurality of objects, and the image information of each of the objects at least includes: the category of the object, and the first feature vector of the image.

Alternatively, determining category information of the object to be recognized according to the first feature vector of the image of the object to be recognized as well as image feature vectors in an image database, includes:

inputting the first feature vector of the image of the object to be recognized into a pre-trained feature quantizer to obtain a second feature vector of the image of the object to be recognized, the second feature vector being a binary feature vector; and
determining category information of the object to be recognized according to the first feature vector and the second feature vector of the image of the object to be recognized as well as image feature vectors in an image database.

Alternatively, the image information of each of the objects in the image database further includes: the second feature vector of the image; and

determining category information of the object to be recognized according to the first feature vector and the second feature vector of the image of the object to be recognized as well as image feature vectors in an image database, includes:
comparing the second feature vector of the image of the object to be recognized with the second feature vector of each image information in the image database, and selecting a set of candidate image information from the image database according to a comparison result; and
comparing the first feature vector of the object to be recognized with the first feature vector of each image information in the set of candidate image information, and determining the category information of the object to be recognized according to a comparison result.

Alternatively, the comparing the second feature vector of the image of the object to be recognized with the second feature vector of each image information in the image database, and selecting a set of candidate image information from the image database according to a comparison result, includes:

performing an exclusive-OR operation on the second feature vector of the image of the object to be recognized and the second feature vector of each image information in the image database to obtain a comparison result which is to be used for labeling a degree of dissimilarity between the image of the object to be recognized and each image information in the image database; and
adding each image information in the image database corresponding to a degree of dissimilarity smaller than a first preset threshold into the set of candidate image information.

Alternatively, the comparing the first feature vector of the object to be recognized with the first feature vector of each image information in the set of candidate image information, and determining the category information of the object to be recognized according to a comparison result, includes:

determining the Euclidean distance between the first feature vector of the image of the object to be recognized and each first feature vector in the set of candidate image information to obtain a degree of dissimilarity between the first feature vector of the image of the object to be recognized and each first feature vector in the set of candidate image information; and
determining category information of the object to be recognized according to the degree of dissimilarity between the first feature vector of the image of the object to be recognized and each first feature vector in the set of candidate image information.

Alternatively, determining category information of the object to be recognized according to the degree of dissimilarity between the first feature vector of the image of the object to be recognized and each first feature vector in the set of candidate image information, includes: taking the category of an object with which the image information in the set of candidate image information corresponding to the minimum degree of dissimilarity is labeled as the category of the object to be recognized.

Alternatively, determining category information of the object to be recognized according to the first feature vector of the image of the object to be recognized as well as image feature vectors in an image database, includes:

comparing the first feature vector of the image of the object to be recognized with the first feature vector of each image information in the image database, and determining the category information of the object to be recognized according to a comparison result.

Alternatively, the comparing the first feature vector of the image of the object to be recognized with the first feature vector of each image information in the image database, and determining the category information of the object to be recognized according to a comparison result, includes:

determining the Euclidean distance between the first feature vector of the image of the object to be recognized and each first feature vector in the image database to obtain a degree of dissimilarity between the first feature vector of the image of the object to be recognized and each first feature vector in the image database; and
determining category information of the object to be recognized according to the degree of dissimilarity between the first feature vector of the image of the object to be recognized and each first feature vector in the image database.

A second aspect of the present application provides an object recognition apparatus, including: a receiving unit, an input unit, and a determination unit; wherein the receiving unit is used for receiving an image of the object to be recognized; the input unit is used for inputting the image of the object to be recognized into a pre-trained image feature extractor to obtain a first feature vector of the image of the object to be recognized; and the determination unit is used for determining category information of the object to be recognized according to the first feature vector of the image of the object to be recognized as well as image feature vectors in an image database, wherein the image database contains image information of a plurality of objects, and the image information of each of the objects at least includes: the category of the object, and the first feature vector of the image.

Alternatively, the determination unit is used for inputting the first feature vector of the image of the object to be recognized into a pre-trained feature quantizer to obtain a second feature vector of the image of the object to be recognized, the second feature vector being a binary feature vector; and

determining category information of the object to be recognized according to the first feature vector and the second feature vector of the image of the object to be recognized as well as image feature vectors in an image database.

Alternatively, the image information of each of the objects in the image database further includes: the second feature vector of the image; and

The determination unit is used for comparing the second feature vector of the image of the object to be recognized with the second feature vector of each image information in the image database, and selecting a set of candidate image information from the image database according to a comparison result; and
comparing the first feature vector of the object to be recognized with the first feature vector of each image information in the set of candidate image information, and determining the category information of the object to be recognized according to a comparison result.

Alternatively, The determination unit is used for performing an exclusive-OR operation on the second feature vector of the image of the object to be recognized and the second feature vector of each image information in the image database to obtain a comparison result which is to be used for labeling a degree of dissimilarity between the image of the object to be recognized and each image information in the image database; and

adding each image information in the image database corresponding to a degree of dissimilarity smaller than a first preset threshold into the set of candidate image information.

Alternatively, the determination unit is used for determining the Euclidean distance between the first feature vector of the image of the object to be recognized and each first feature vector in the set of candidate image information to obtain a degree of dissimilarity between the first feature vector of the image of the object to be recognized and each first feature vector in the set of candidate image information; and

determining category information of the object to be recognized according to the degree of dissimilarity between the first feature vector of the image of the object to be recognized and each first feature vector in the set of candidate image information.

Alternatively, the determination unit is used for taking the category of an object with which the image information in the set of candidate image information corresponding to the minimum degree of dissimilarity is labeled as the category of the object to be recognized.

Alternatively, the determination unit is used for comparing the first feature vector of the image of the object to be recognized with the first feature vector of each image information in the image database, and determining the category information of the object to be recognized according to a comparison result.

Alternatively, the determination unit is used for determining the Euclidean distance between the first feature vector of the image of the object to be recognized and each first feature vector in the image database to obtain a degree of dissimilarity between the first feature vector of the image of the object to be recognized and each first feature vector in the image database; and determining category information of the object to be recognized according to the degree of dissimilarity between the first feature vector of the image of the object to be recognized and each first feature vector in the image database.

A third aspect of the present application provides an electronic device, including: a processor, a storage medium, and a bus, wherein the storage medium stores machine-readable instructions executable by the processor, and when the electronic device is in operation, the processor communicates with the storage medium over the bus, and executes the machine-readable instructions to perform the steps of the method of the first aspect described above.

A fourth aspect of the present application provides a storage medium having stored thereon a computer program which, when executed by a processor, performs the steps of the method of the first aspect described above.

The present application provides an object recognition method and apparatus, and a storage medium. The object recognition method includes: receiving an image of an object to be recognized; inputting the image of the object to be recognized into a pre-trained image feature extractor to obtain a first feature vector of the image of the object to be recognized; determining category information of the object to be recognized according to the first feature vector of the image of the object to be recognized as well as image feature vectors in an image database, wherein the image database contains image information of a plurality of objects, and the image information of each of the objects at least includes: the category of the object, and the first feature vector of the image. According to the technical scheme, with the pre-trained image feature extractor, the first feature vector of the inputted image of the object to be recognized can be extracted, so that the category information of the object to be recognized can be finally determined according to the relationship between the extracted first feature vector of the image and the image feature vectors prestored in the image database extracted by the image feature extractor. By determining the category information of the object to be recognized according to the relationship between the first feature vector and the image feature vectors in the image database, the problem that image features cannot be accurately learned when the dataset is small and there is an unbalance in the distribution of the categories in the data, leading to inaccurate classification is prevented, thereby improving the accuracy of object recognition.

### BRIEF DESCRIPTION OF THE DRAWINGS

In order to more clearly illustrate the technical solution of the embodiments of the present application, the drawings used in the embodiments will be briefly described. It is to be understood that the following drawings illustrate only some embodiments of the present application and are therefore not to be considered limiting of its scope. For those skilled in the art, other relevant drawings can be obtained from these drawings without involving any inventive effort.

FIG. 1 shows a block diagram of an object recognition system provided by an embodiment of the present application;

FIG. 2 shows a schematic diagram of exemplary hardware and software components of an electronic device that may implement the concepts of the present application provided by an embodiment of the present application;

FIG. 3 shows a flowchart of an object recognition method provided by an embodiment of the present application;

FIG. 4 shows a flowchart of an object recognition method provided by another embodiment of the present application;

FIG. 5 shows a flowchart of an object recognition method provided by another embodiment of the present application;

FIG. 6 shows a flowchart of an object recognition method provided by another embodiment of the present application;

FIG. 7 shows a flowchart of an object recognition method provided by another embodiment of the present application;

FIG. 8 shows a flowchart of an object recognition method provided by another embodiment of the present application;

FIG. 9 shows a schematic diagram illustrating the structure of an object recognition device provided by an embodiment of the present application; and

FIG. 10 shows a schematic diagram illustrating the structure of an electronic device provided by an embodiment of the present application.

### DETAILED DESCRIPTION

In order to make the purpose, technical solutions and advantages of the embodiments of the present application clearer, the technical solutions in the embodiments of the present application will be described clearly and completely in conjunction with the drawings in the embodiments of the present application. It is to be understood that the drawings are for purposes of illustration and description only and are not intended to limit the scope of the present application. In addition, it is to be understood that the illustrative drawings are not drawn to scale. The flowcharts used in the present application illustrate operations implemented in accordance with some embodiments of the present application. It should be understood that the operations of the flowcharts may be implemented out of order and that the steps without logical context may be performed in reverse order or concurrently. In addition, under the guidance of the content of this application, those skilled in the art can add one or more other operations to the flowcharts, or remove one or more operations from the flowcharts.

In addition, the described embodiments are only a part of, but not all of the embodiments of the present application. The components of the embodiments of the present application, which are generally described and illustrated in the drawings herein, may be arranged and designed in a variety of different configurations. Therefore, the following detailed description of the embodiments of the present application provided in the accompanying drawings is not intended to limit the scope of the claimed application, but is merely representative of selected embodiments of the application. Based on the embodiments of the present application, all other embodiments obtained by those skilled in the art without involving any inventive effort are within the scope of protection of the present application.

It should be noted that in the embodiments of the present application the term “comprising/comprises, including/includes” will be used to indicate the presence of the features listed thereafter, but does not exclude the addition of other features.

It should be noted that: like numbers and letters refer to like items in the following figures, and thus, once an item is defined in one figure, it need not be further defined and explained in subsequent figures.

Furthermore, the terms “first, second”, and the like, if any, are used solely for distinguishing descriptions and are not to be construed as indicating or implying relative importance.

It should be noted that features in embodiments of the present application may be combined without conflict.

An existing dish recognition method generally adopts the technical framework of image classification, which is to train a classification model according to a loss function for classification (usually the cross-entropy loss function) for a given dish dataset. This method has the following defects:

(1) As the loss function for classification is used, when there is an unbalance between the categories of dishes in the dish dataset (for example: some categories of dishes have tens of thousands of images in the dish dataset, while some categories of dishes have only a few images in the dish dataset), especially for dish datasets with small samples, useful feature information cannot learned, so that the classification is not effective for dish categories with small samples.

(2) When there is any modification to the categories of dishes, for example: when a new category of dish is added or when a category of dish is to be deleted, the model needs to be retrained. However, the process of retraining consumes a lot of computing and human resources, which is not conducive to the iterative development of projects.

In order to solve the technical problem in the prior art, the present application proposes an inventive concept: first feature vectors of images of all dishes are stored in advance, an image of a dish to be recognized is extracted by a pre-trained image feature extractor to obtain a first feature vector of the image of the dish to be recognized, and category information of the dish to be recognized is determined by judging the relationship between the first feature vector of the image of the dish to be recognized and the first feature vectors of the images of dishes prestored in an image database. According to the method, the issue of classification is converted into judgement on the relationship between feature vectors, and the problem that the classification of the classification model is not effective when there is an unbalance between the categories in the dish dataset is prevented.

The specific technical solutions provided by the present application are described below by means of possible implementations.

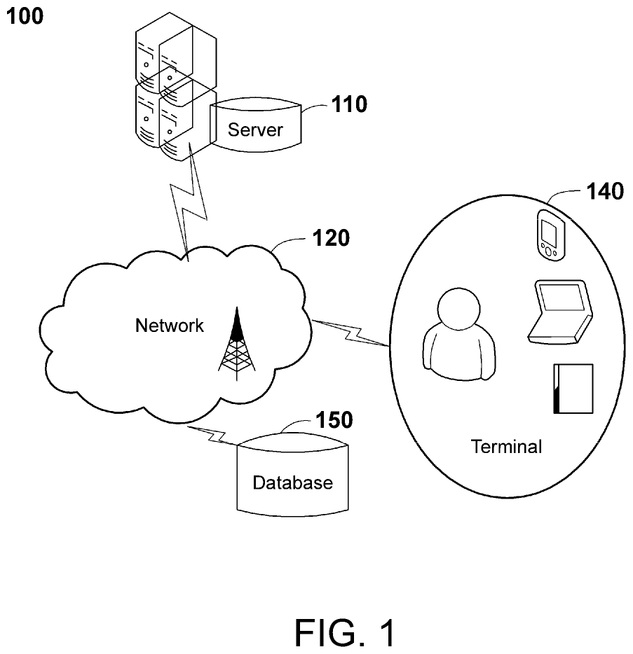

FIG. 1 shows a block diagram of an object recognition system provided by an embodiment of the present application. For example, the object recognition system 100 may be used in some object recognition systems such as a dish recognition system, a flower recognition system, etc. The object recognition system 100 may include one or more of a server 110, a network 120, a terminal 140, and a database 150, and the server 110 may include a processor to perform instruction operations.

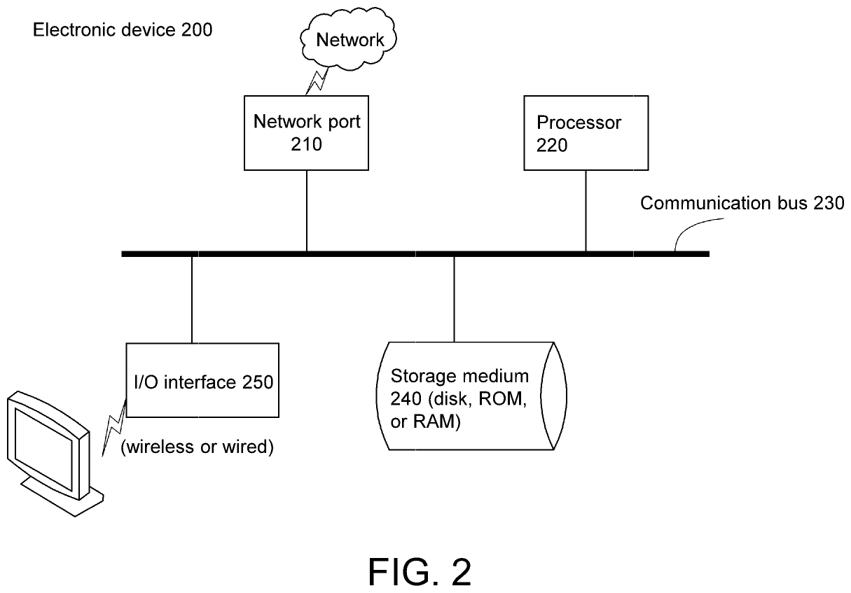

In some embodiments, the server 110 may be a single server or a server group. The server group may be centralized or distributed (e.g., the server 110 may be a distributed system). In some embodiments, the server 110 may be local or remote with respect to the terminal. For example, the server 110 may access information and/or data stored in the terminal 140, or the database 150, or any combination thereof, via the network 120. As another example, the server 110 may be directly connected to at least one of the terminal 140 and the database 150 to access information and/or data stored thereon. In some embodiments, the server 110 may be implemented on a cloud platform; by way of example only, the cloud platform may include a private cloud, a public cloud, a mixed cloud, a community cloud, a distributed cloud, an inter-cloud, a multi-cloud, etc., or any combination thereof. In some embodiments, the server 110 may be implemented on an electronic device 200 having one or more of the components shown in FIG. 2 of the present application.

In some embodiments, the server 110 may include a processor. The processor may process information and/or data related to a service request to perform one or more functions described herein. For example, the processor may determine feature information of an object to be recognized based on an image of the object obtained from the terminal 130. In some embodiments, the processor may include one or more processing cores (e.g., a single-core processor (S) or a multi-core processor (S)). By way of example only, a processor may include a Central Processing Unit (CPU), an Application Specific Integrated Circuit (ASIC), an Application Specific Instruction-set Processor (ASIP), a Graphics Processing Unit (GPU), a Physical Processing Unit (PPU), a Digital Signal Processor (DSP), a Field Programmable Gate Array (FPGA), a Programmable Logic Device (PLD), a controller, a microcontroller unit, a Reduced Instruction Set Computing (RISC), a microprocessor, or the like, or any combination thereof.

The network 120 may be used for the exchange of information and/or data. In some embodiments, one or more components (e.g., the server 110, the terminal 140, and the database 150) of the object recognition system 100 may transmit information and/or data to other components. For example, the server 110 may obtain an image of the object to be recognized from the terminal 130 via the network 120. In some embodiments, the network 120 may be a wired or wireless network of any type, or combination thereof. By way of example only, the network 120 may include a wired network, a wireless network, a fiber optic network, a telecommunication network, an intranet, the Internet, a Local Area Network (LAN), a Wide Area Network (WAN), a Wireless Local Area Network (WLAN), a Metropolitan Area Network (MAN), a Public Switched Telephone Network (PSTN), a Bluetooth network, a ZigBee network, or a Near Field Communication (NFC) network, and the like, or any combination thereof. In some embodiments, the network 120 may include one or more network access points. For example, the network 120 may include a wired or wireless network access point, such as a base station and/or a network switching node, through which one or more components of the object recognition system 100 may be connected to the network 120 to exchange data and/or information.

In some embodiments, the terminal 140 may include a mobile device, a tablet computer, etc., or any combination thereof.

FIG. 2 shows a schematic diagram of exemplary hardware and software components of an electronic device that may implement the concepts of the present application provided by an embodiment of the present application. For example, the processor 220 may be applied in an electronic device 200 to perform the functions of the present application.

The electronic device 200 may be a general purpose computer or a special purpose computer, both of which may be used to implement the object recognition method of the present application. Although only one computer is shown in the present application, for convenience, the functions described herein may be implemented in a distributed fashion on a plurality of similar platforms to balance processing load.

For example, the electronic device 200 may include a network port 210 connected to a network, one or more processors 220 for executing program instructions, a communication bus 230, and a storage medium 240 of various forms, such as a disk, ROM, or RAM, or any combination thereof. Illustratively, the computer platform may also include program instructions stored in the ROM, RAM, or other types of non-transitory storage media, or any combination thereof. The method of the present application may be implemented in accordance with these program instructions. The electronic device 200 also includes an input/output (I/O) interface 250 between the computer and other input/output devices (e.g., a keyboard, a display screen).

For ease of illustration, only one processor is depicted in the electronic device 200. However, it should be noted that the electronic device 200 of the present application may also include multiple processors, and therefore the steps performed by one processor described herein may also be performed by multiple processors in combination or separately. For example, if the processor of the electronic device 200 performs steps A and B, it should be understood that steps A and B may also be performed jointly by two different processors or separately in one processor. For example, the first processor performs step A, the second processor performs step B, or the first processor and the second processor perform steps A and B jointly.

The implementation principles of the object recognition method provided herein and corresponding beneficial effects are explained through a plurality of specific embodiments as follows.

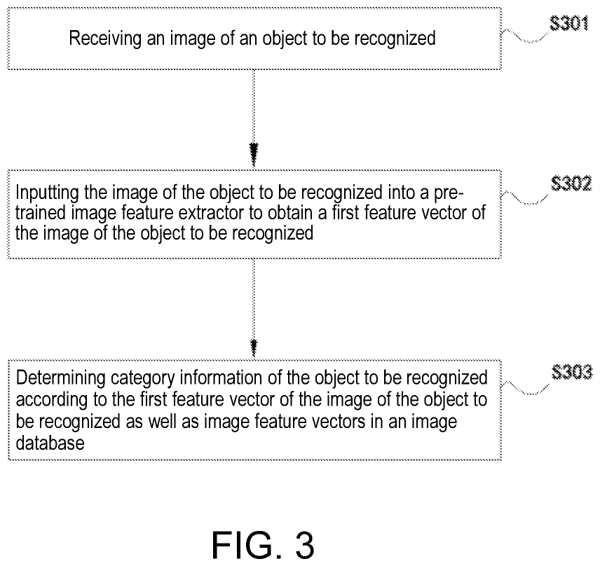

FIG. 3 shows a flowchart of an object recognition method provided by an embodiment of the present application, and an executive body of the method may be a processing device such as an intelligent mobile device, a computer, a server, and the like. As shown in FIG. 3, the method may include:

S301, an image of an object to be recognized is received.

Illustratively, in the embodiments of the present application, the image of the object to be recognized may be an image of a dish to be recognized, an image of a flower to be recognized, or an image of a face to be recognized, etc., and the present application does not limit the specific type of object to be recognized. For ease of description, the following embodiments all take dishes as examples for description.

Of course, the foregoing merely exemplifies several application scenarios and, in practice, is not limited to the application scenarios described above.

S302, the image of the object to be recognized is inputted into a pre-trained image feature extractor to obtain a first feature vector of the image of the object to be recognized.

In an embodiment of the present application, the image feature extractor is trained from a database containing images of dishes of all current categories. It should be noted that this database contains not only the images of dishes of all current categories, but also label data of the images of all dishes. In addition, the image feature extractor is trained by metric learning, which is also called similarity learning.

The image feature extractor may adopt an existing neural network model, and illustratively, the image feature extractor may be obtained by training a dish database based on a twin network model. Further, the loss function of the feature extractor may employ a loss function such as triplet loss. It should be noted that the selection of the network model and loss function described above is exemplary only, and the selection of the particular network model and loss function is not so limited.

When an image of a dish to be recognized is received, the first feature vector of the image of the dish to be recognized is obtained with the image feature extractor.

In an alternative, the first feature vector of the image of the object to be recognized may be a feature vector in the form of floating-point number. The first feature vector may completely describe the feature information of each dish image.

S303, category information of the object to be recognized is determined according to the first feature vector of the image of the object to be recognized as well as image feature vectors in an image database.

Alternatively, the image database contains image information of a plurality of objects, and the image information of each of the objects at least includes: the category of the object, and the first feature vector of the image. Illustratively, the image database may include: images of dishes, the categories of the images of dishes, and the first feature vectors of the images of dishes.

In this embodiment, the category information of the dish to be recognized is determined according to the relationship between the feature vectors of all the pre-stored images of dishes in the image database and the first feature vector of the image of the dish to be recognized.

In summary, this embodiment provides an object recognition method, including: an image of an object to be recognized is received; the image of the object to be recognized is inputted into a pre-trained image feature extractor to obtain a first feature vector of the image of the object to be recognized; and category information of the object to be recognized is determined according to the first feature vector of the image of the object to be recognized as well as image feature vectors in an image database, wherein the image database contains image information of a plurality of objects, and the image information of each of the objects at least includes: the category of the object, and the first feature vector of the image. According to the technical scheme, with the pre-trained image feature extractor, the first feature vector of the inputted image of the object to be recognized can be extracted, so that the category information of the object to be recognized can be finally determined according to the relationship between the extracted first feature vector of the image and the image feature vectors prestored in the image database extracted by the image feature extractor. By determining the category information of the object to be recognized according to the relationship between the first feature vector and the image feature vectors in the image database, the problem that image features cannot be accurately learned when the dataset is small and there is an unbalance in the distribution of the categories in the data, leading to inaccurate classification is prevented, thereby improving the accuracy of object recognition. In addition, according to the object recognition method provided by the embodiment of the application, when an object category is to be deleted or added, the first feature vector of the newly added category of dish can be extracted by the feature extractor, and directly added to the image database, or the first feature vector of the category of dish to be deleted can be directly deleted from the image database without retraining the network model. Therefore, manpower and equipment resources are saved to a certain extent, and iterative development of the project is improved.

In step S303, the category information of the object to be recognized may be determined according to the first feature vector of the image of the object to be recognized as well as image feature vectors in an image database in the following two alternatives.

In a first alternative, the category information of the object to be recognized may be determined directly from the first feature vector and the image feature vectors in the image database.

In a second alternative, the category information of the object to be recognized may be determined on the basis of the first feature vector and the image feature vectors in the image database simultaneously in combination with the second feature vector of the object to be recognized.

These two alternatives are described separately below.

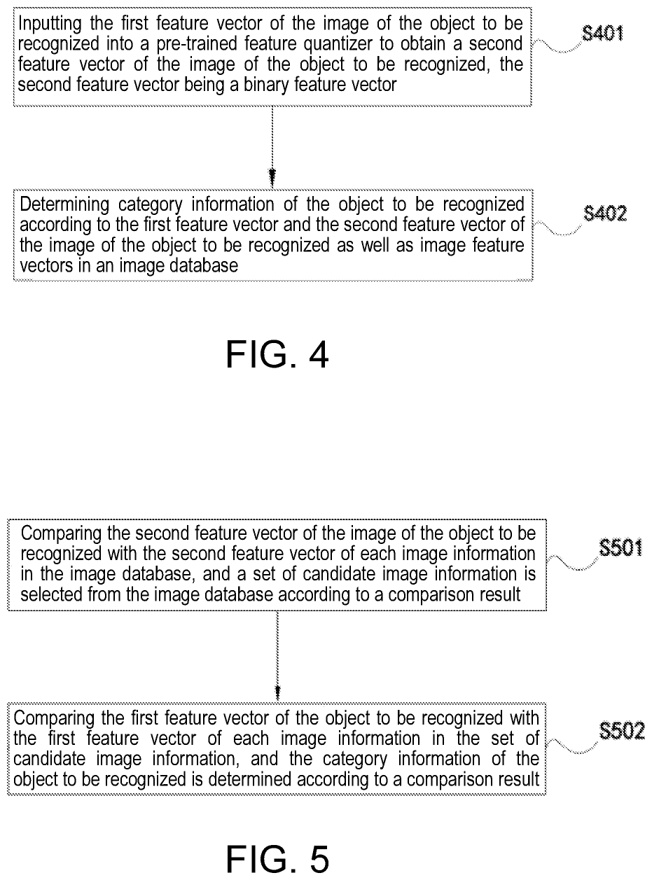

FIG. 4 shows a flowchart of an object recognition method provided by an embodiment of the present application. Alternatively, as shown in FIG. 4, the second alternative of the above step includes:

S401, the first feature vector of the image of the object to be recognized is inputted into a pre-trained feature quantizer to obtain a second feature vector of the image of the object to be recognized, the second feature vector being a binary feature vector.

In an embodiment of the present application, the first feature vector may be further converted into a second feature vector in order to reduce data computation. Specifically, the first feature vector is inputted into a pre-trained feature quantizer, and the second feature vector is output by the feature quantizer.

It is to be noted that in the embodiment of the present application, firstly, an image of a dish to be recognized is inputted into a feature extractor to obtain a first feature vector of all dishes, and then the feature quantizer takes the first feature vector as an input, and finally outputs a binarized first feature vector, namely the second feature vector. The second feature vector is stored in a binary format.

Furthermore, it should be noted that in practical applications, the second feature vector may also be converted into other formats for the determination of the category information of the dish. That is, as long as the dimensionality of the first feature vector can be reduced.

S402, category information of the object to be recognized is determined according to the first feature vector and the second feature vector of the image of the object to be recognized as well as image feature vectors in an image database.

In one implementation, the category information of the dish to be recognized may be determined directly from the first feature vector of the image of the dish to be recognized and the image feature vectors in the image database.

In another implementation, the category information of the dish to be recognized may be determined from the second feature vector of the image of the dish to be recognized and the image feature vectors in the image database.

In addition, the category information of the dish to be recognized may be determined from the combination of the first feature vector and the second feature vector of the dish to be recognized as well as the image feature vectors in the database.

FIG. 5 shows a flowchart of an object recognition method provided by another embodiment of the present application. Alternatively, the image information of each of the objects in the image database further includes: the second feature vector of the image; as shown in FIG. 5, the above step S402 may include:

S501, the second feature vector of the image of the object to be recognized is compared with the second feature vector of each image information in the image database, and a set of candidate image information is selected from the image database according to a comparison result.

In this embodiment, the image database contains the second feature vector of each image information, and the set of candidate image information is firstly selected by comparing the second feature vector of the image of the dish to be recognized with the second feature vector of each image information in the database.

It is to be noted that, in the embodiment of the present application, the set of candidate image information is a set of information selected from a pre-stored image database containing the first feature vectors of images, the second feature vectors of images, and category information of images and satisfying a preset condition. Alternatively, the second feature vector of each image corresponds to a unique first feature vector and category information of the image.

S502, the first feature vector of the object to be recognized is compared with the first feature vector of each image information in the set of candidate image information, and the category information of the object to be recognized is determined according to a comparison result.

In this embodiment, after the set of candidate image information is selected, the first feature vector of the dish to be recognized is directly compared with the first feature vector of each image information in the set of candidate image information, and the category information of the dish to be recognized is determined according to the comparison result.

In this embodiment, the set of image information is selected based on the second feature vector, and on the basis of the selected set of image information, the first feature vector of the dish to be recognized is directly compared with the first feature vector of each image information in the set of image information, so that it is prevented from comparing the first feature vector with the first feature vectors of all image information prestored in the database. That is, by getting a set of candidate image information in advance, the image feature vectors are coarsely filtered, the requirement on the hashrate of the computer is reduced in some degree, and the speed of determining the category information of the dish to be recognized is accelerated.

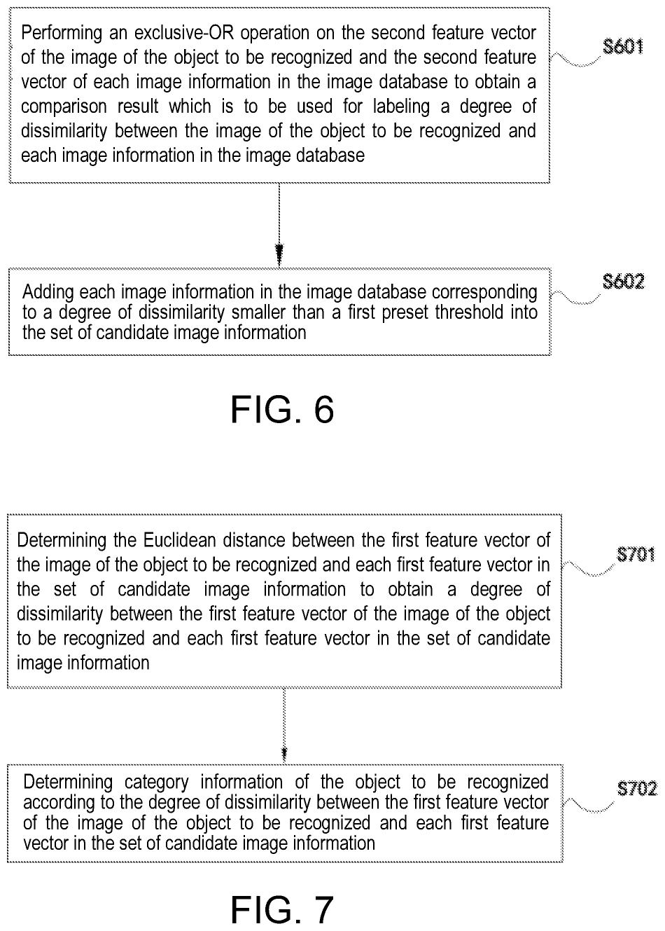

FIG. 6 shows a flowchart of an object recognition method provided by another embodiment of the present application. As shown in FIG. 6, the above step S501 specifically includes:

S601, an exclusive-OR operation is performed on the second feature vector of the image of the object to be recognized and the second feature vector of each image information in the image database to obtain a comparison result which is to be used for labeling a degree of dissimilarity between the image of the object to be recognized and each image information in the image database.

In the embodiment of the present application, the degree of dissimilarity between the second feature vector of the image of the dish to be recognized and the second feature vector of each image information in the image database can be calculated by means of exclusive-OR operation.

The general rules for exclusive-OR operation are as follows: if the value of the second feature vector of the image of the dish to be recognized and the value of the second feature vector of a certain image information in the database are not the same, the result of the exclusive-OR operation is 1. If the value of the second feature vector of the image of the dish to be recognized is as same as the value of the second feature vector of a certain image information in the database, the result of the exclusive-OR operation is 0. Illustratively, in this embodiment, when the second feature vector of the image of the dish to be recognized is 101010111, which is subjected to an exclusive-OR operation with a second feature vector 111001011 prestored in the image database, the comparison result should be 010011100.

S602, each image information in the image database corresponding to a degree of dissimilarity smaller than a first preset threshold is added into the set of candidate image information.

In the embodiment of the present application, each image information in the image database corresponding to a degree of dissimilarity smaller than a first preset threshold may be added into the set of candidate image information. Besides, similarity information of the dish to be recognized and the second feature vectors prestored in the database can be calculated, and each image information in the image database corresponding to a degree of similarity larger than a certain preset threshold may be added into the set of candidate image information.

It should be noted that the determination of the first preset threshold can be specifically set according to the hardware of the device, and the embodiments of the present application are not limited in this respect.

FIG. 7 shows a flowchart of an object recognition method provided by another embodiment of the present application. As shown in FIG. 7, the above step S501 specifically includes:

S701, the Euclidean distance between the first feature vector of the image of the object to be recognized and each first feature vector in the set of candidate image information is determined to obtain a degree of dissimilarity between the first feature vector of the image of the object to be recognized and each first feature vector in the set of candidate image information.

S702, category information of the object to be recognized is determined according to the degree of dissimilarity between the first feature vector of the image of the object to be recognized and each first feature vector in the set of candidate image information.

Alternatively, the Euclidean distance between the first feature vector of the image of the object to be recognized and the first feature vector of each image in the set of candidate image information may be calculated to determine the degree of dissimilarity between the image of the object to be recognized and each image in the set of candidate image information, and the images are sorted by the degree of dissimilarity, thereby finally determining the category information of the dish to be recognized.

Alternatively, in step S702, that category information of the object to be recognized is determined according to the degree of dissimilarity between the first feature vector of the image of the object to be recognized and each first feature vector in the set of candidate image information, may include: the category of an object, with which the image information in the set of candidate image information corresponding to the minimum degree of dissimilarity is labeled, is taken as the category of the object to be recognized.

It can be understood that in the embodiment of the present application, the category of an object, with which the image information in the set of candidate image information corresponding to the minimum degree of dissimilarity is labeled, is taken as the category of the object to be recognized, i.e. dissimilarity calculation is used instead of the model classification method in the prior art, so that the technical problem that in the case of training with a small sample, the classification model cannot learn useful information of the images, leading to inaccurate classification is solved.

Alternatively, step S303 may specifically include: the first feature vector of the image of the object to be recognized is compared with the first feature vector of each image information in the image database, and the category information of the object to be recognized is determined according to a comparison result.

The first alternative described above, i.e. the category of the object to be recognized is determined directly from the first feature vector and the image feature vectors in the image database, is described below.

In a possible implementation, when the hashrate of the computing device is sufficient to meet the speed requirement for object recognition, the category information of the object to be recognized may be determined directly using the first feature vector of the object to be recognized and the image feature vectors in the image database. Alternatively, the first feature vector of the image of the object to be recognized may be compared with the first feature vector of each image information in the image database, and the category information of the object to be recognized is determined according to a comparison result.

The category information of the dish to be recognized is determined according to the degree of dissimilarity obtained by directly comparing the first feature vector of the dish to be recognized with the first feature vector of each image information in the image database. In this way, the speed of recognizing the category of the dish to be recognized and the accuracy of recognition can be improved in a certain degree.

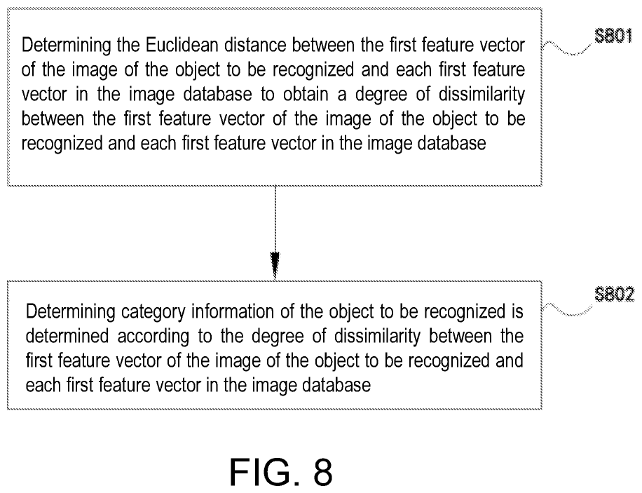

FIG. 8 shows a flowchart of an object recognition method provided by yet another embodiment of the present application. As show in FIG. 8, that the first feature vector of the image of the object to be recognized is compared with the first feature vector of each image information in the image database, and the category information of the object to be recognized is determined according to a comparison result, may specially include:

S801, the Euclidean distance between the first feature vector of the image of the object to be recognized and each first feature vector in the image database is determined to obtain a degree of dissimilarity between the first feature vector of the image of the object to be recognized and each first feature vector in the image database.

S802, category information of the object to be recognized is determined according to the degree of dissimilarity between the first feature vector of the image of the object to be recognized and each first feature vector in the image database.

In this embodiment, the degree of dissimilarity between the first feature vector of the image of the dish to be recognized and each first feature vector in the image database is obtained by calculating the Euclidean distance, and then the category information of the object to be recognized is determined according to the degree of dissimilarity.

Alternatively, the category of a dish corresponding to the first feature vector with the lowest degree of dissimilarity in the image database can be found out to be taken as the category information of the dish to be recognized.

It can be understood that, according to the object recognition method provided by the embodiment of the application, when a category of dish is to be deleted or added, the first feature vector of the newly added category of dish can be extracted by the feature extractor and then processed by the feature quantizer to obtained the second feature vector, and the first feature vector and the second feature vector are directly added to the image database, or the first feature vector and the second feature vector of the category of dish to be deleted can be directly deleted from the image database without retraining the network model. Therefore, manpower and equipment resources are saved to a certain extent, and iterative development of the project is improved.

Hereinafter, an apparatus for performing the object recognition method provided by the present application and a storage medium will be described, and specific implementation processes and technical effects thereof can refer to the above, and will not be repeated in the following description.

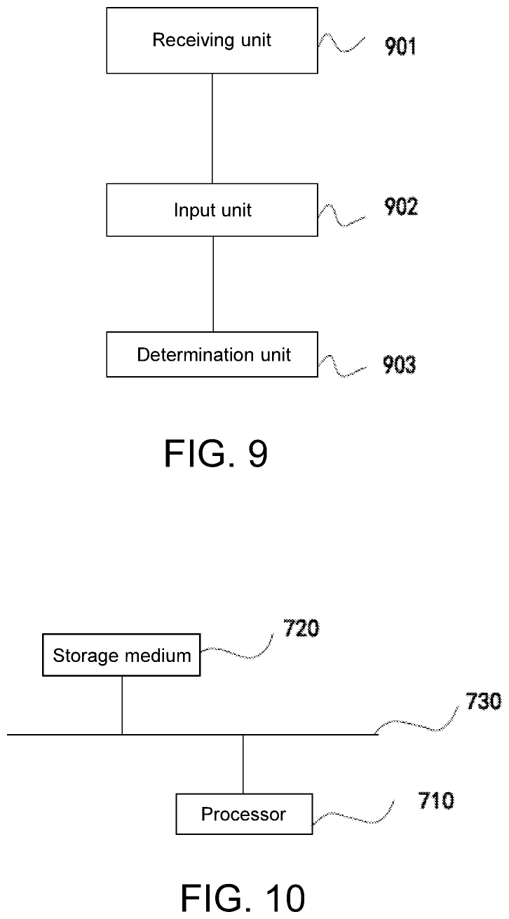

FIG. 9 shows a schematic diagram illustrating an object recognition device provided by the present application. As shown in FIG. 9, the device may include: a receiving unit 901, an input unit 902, and a determination unit 903; wherein the receiving unit 901 is used for receiving an image of the object to be recognized; the input unit 902 is used for inputting the image of the object to be recognized into a pre-trained image feature extractor to obtain a first feature vector of the image of the object to be recognized; and the determination unit 903 is used for determining category information of the object to be recognized according to the first feature vector of the image of the object to be recognized as well as image feature vectors in an image database, wherein the image database contains image information of a plurality of objects, and the image information of each of the objects at least includes: the category of the object, and the first feature vector of the image.

Alternatively, the determination unit 903 is used for inputting the first feature vector of the image of the object to be recognized into a pre-trained feature quantizer to obtain a second feature vector of the image of the object to be recognized, the second feature vector being a binary feature vector; and determining category information of the object to be recognized according to the first feature vector and the second feature vector of the image of the object to be recognized as well as image feature vectors in an image database.

Alternatively, the image information of each of the objects in the image database further comprises: the second feature vector of the image; and the determination unit 903 is used for comparing the second feature vector of the image of the object to be recognized with the second feature vector of each image information in the image database, and selecting a set of candidate image information from the image database according to a comparison result; and comparing the first feature vector of the object to be recognized with the first feature vector of each image information in the set of candidate image information, and the category information of the object to be recognized is determined according to a comparison result.

Alternatively, the determination unit 903 is used for performing an exclusive-OR operation on the second feature vector of the image of the object to be recognized and the second feature vector of each image information in the image database to obtain a comparison result which is to be used for labeling a degree of dissimilarity between the image of the object to be recognized and each image information in the image database; and adding each image information in the image database corresponding to a degree of dissimilarity smaller than a first preset threshold into the set of candidate image information.

Alternatively, the determination unit 903 is used for determining the Euclidean distance between the first feature vector of the image of the object to be recognized and each first feature vector in the set of candidate image information to obtain a degree of dissimilarity between the first feature vector of the image of the object to be recognized and each first feature vector in the set of candidate image information; and determining category information of the object to be recognized according to the degree of dissimilarity between the first feature vector of the image of the object to be recognized and each first feature vector in the set of candidate image information.

Alternatively, the determination unit 903 is used for taking the category of an object with which the image information in the set of candidate image information corresponding to the minimum degree of dissimilarity is labeled as the category of the object to be recognized.

Alternatively, the determination unit 903 is used for comparing the first feature vector of the image of the object to be recognized with the first feature vector of each image information in the image database, and determining the category information of the object to be recognized according to a comparison result.

Alternatively, the determination unit 903 is used for determining the Euclidean distance between the first feature vector of the image of the object to be recognized and each first feature vector in the image database to obtain a degree of dissimilarity between the first feature vector of the image of the object to be recognized and each first feature vector in the image database; and determining category information of the object to be recognized according to the degree of dissimilarity between the first feature vector of the image of the object to be recognized and each first feature vector in the image database.

FIG. 10 shows a schematic diagram illustrating the structure of an electronic device provided by an embodiment of the present application. The electronic device includes: a processor 710, a storage medium 720, and a bus 730, wherein the storage medium 720 stores machine-readable instructions executable by the processor 710, and when the electronic device is in operation, the processor 710 communicates with the storage medium 720 over the bus 730, and executes the machine-readable instructions to perform the steps of the method embodiments described above. Specific implementations and technical effects are similar and will not be described in detail herein.

A embodiment of the present application provides a storage medium having stored thereon a computer program which, when executed by a processor, performs the method described above.

In the several embodiments provided herein, it is to be understood that the disclosed apparatus and method may be implemented in other ways. For example, the apparatus embodiment described above is merely illustrative, e.g., the division of the elements is just a division of logical functions, and there may be additional divisions in actual implementation, e.g., multiple elements or components may be combined or integrated into another system, or some features may be omitted, or not performed. Alternatively, the couplings or direct couplings or communicative connections shown or discussed with respect to one another may be indirect couplings or communicative connections through some interfaces, devices or elements, and may be electrical, mechanical or otherwise.

The elements described as separate elements may or may not be physically separate, and the elements shown as elements may or may not be physical elements, i.e. may be located at one place, or may be distributed over a plurality of network elements. Some or all of the elements may be selected to achieve the objectives of the embodiments according to practical requirements.

In addition, each functional unit in each embodiment of the present application may be integrated in one processing unit, each unit may be physically present separately, or two or more units may be integrated in one unit. The integrated units described above can be implemented either in hardware or in hardware plus software functional units.

The integrated units described above, implemented in the form of software functional units, may be stored in a computer-readable storage medium. The software functional unit is stored in a storage medium and includes instructions for causing a computer device (which may be a personal computer, a server, a network device, etc.) or a processor to perform some of the steps of the method described in various embodiments of the present application. The afore-mentioned storage medium includes: u disk, mobile hard disk, Read-Only Memory (ROM), Random Access Memory (RAM), magnetic or optical disks, and various media on which program code may be stored.

Although the present invention has been described in detail with reference to specific embodiments thereof, it is to be understood that the scope of the present invention is not limited thereto, and that various changes and substitutions may be made therein by those skilled in the art without departing from the scope of the present invention. Therefore, the scope of protection of the present application should be determined by the scope of the claims.

What is claimed is:

1. An object recognition method, comprising:
receiving an image of an object to be recognized;
inputting the image of the object to be recognized into a pre-trained image feature extractor to obtain a first feature vector of the image of the object to be recognized; and
determining category information of the object to be recognized according to the first feature vector of the image of the object to be recognized and image feature vectors in an image database, wherein the image database contains image information of a plurality of objects, wherein the image information of each of the plurality of objects at least comprises the category information of the object and the first feature vector of the image, wherein the first feature vector is a feature vector in the form of floating-point number;
wherein determining the category information of the object to be recognized according to the first feature vector of the image of the object to be recognized as well as image feature vectors in the image database comprises:
inputting the first feature vector of the image of the object to be recognized into a pre-trained feature quantizer to obtain a second feature vector of the image of the object to be recognized, and the second feature vector being a binary feature vector; and
determining the category information of the object to be recognized according to the first feature vector and the second feature vector of the image of the object to be recognized as well as image feature vectors in an image database.

2. The object recognition method according to claim 1, wherein the image information of each of the plurality of objects in the image database further comprises the second feature vector of the image, wherein
determining the category information of the object to be recognized according to the first feature vector and the second feature vector of the image of the object to be recognized and image feature vectors in an image database comprises:
comparing the second feature vector of the image of the object to be recognized with the second feature vector of each image information in the image database, and selecting a set of candidate image information from the image database according to a comparison result; and
comparing the first feature vector of the object to be recognized with the first feature vector of each image information in the set of candidate image information, and determining the category information of the object to be recognized according to the comparison result.

3. The object recognition method according to claim 2, wherein comparing the second feature vector of the image of the object to be recognized with the second feature vector of each image information in the image database, and selecting the set of candidate image information from the image database according to the comparison result comprises:
performing an exclusive-OR operation on the second feature vector of the image of the object to be recognized and the second feature vector of each image information in the image database to obtain the comparison result being used for labeling a degree of dissimilarity between the image of the object to be recognized and each image information in the image database; and
adding each image information in the image database corresponding to the degree of dissimilarity smaller than a first preset threshold into the set of candidate image information.

4. The object recognition method according to claim 2, wherein comparing the first feature vector of the object to be recognized with the first feature vector of each image information in the set of the candidate image information, and determining the category information of the object to be recognized according to the comparison result comprises:
determining an Euclidean distance between the first feature vector of the image of the object to be recognized and each first feature vector in the set of the candidate image information to obtain a degree of dissimilarity between the first feature vector of the image of the object to be recognized and each first feature vector in the set of the candidate image information; and
determining the category information of the object to be recognized according to the degree of dissimilarity between the first feature vector of the image of the object to be recognized and each first feature vector in the set of the candidate image information.

5. The object recognition method according to claim 4, wherein determining category information of the object to be recognized according to the degree of dissimilarity between the first feature vector of the image of the object to be recognized and each first feature vector in the set of the candidate image information comprises:
taking the category information of the object with which the image information in the set of the candidate image information corresponding to the minimum degree of dissimilarity is labeled as the category of the object to be recognized.

6. The object recognition method according to claim 1, wherein determining the category information of the object to be recognized according to the first feature vector of the image of the object to be recognized as well as image feature vectors in the image database comprises:
comparing the first feature vector of the image of the object to be recognized with the first feature vector of each image information in the image database, and determining the category information of the object to be recognized according to a comparison result.

7. An object recognition apparatus, comprising:
a receiving unit, an input unit, and a determination unit; wherein
the receiving unit is configured to receive an image of the object to be recognized;
the input unit is configured to input the image of the object to be recognized into a pre-trained image feature extractor to obtain a first feature vector of the image of the object to be recognized; and
the determination unit is configured to determine category information of the object to be recognized according to the first feature vector of the image of the object to be recognized as well as image feature vectors in an image database, wherein the image database comprises image information of a plurality of objects, wherein the image information of each of the plurality of objects at least comprises the category information of the object, and the first feature vector of the image, wherein the first feature vector is a feature vector in the form of floating-point number;
the determination unit is configured to input the first feature vector of the image of the object to be recognized into a pre-trained feature quantizer to obtain a second feature vector of the image of the object to be recognized, and the second feature vector being a binary feature vector; and
determining category information of the object to be recognized according to the first feature vector and the second feature vector of the image of the object to be recognized and image feature vectors in an image database.

8. An electronic device, comprising a processor, a storage medium, and a bus, wherein the storage medium stores machine-readable instructions executable by the processor, and when the electronic device is in operation, the processor communicates with the storage medium over the bus, and executes the machine-readable instructions to perform the object recognition method of claim 1.
